(19) United States
(12) Patent Application Publication
(10) Pub. No.: US 2009/0158025 A1
(43) Pub. Date: Jun. 18, 2009

(54) DUAL BIOS CIRCUIT

(75) Inventors: JUI-TING HUNG, Tu-Cheng (TW); CHIH-MING KUO, Tu-Cheng (TW); MING-YI SHIH, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/963,863

(22) Filed: Dec. 24, 2007

(30) Foreign Application Priority Data
Dec. 12, 2007 (CN) 200710203019.6

(51) Int. Cl. G06F 15/177

(52) U.S. Cl. 713/2

(57) ABSTRACT

A dual BIOS circuit includes a first BIOS chip, a second BIOS chip, a power supply, and a switch. The first BIOS chip is connected to a Southbridge chip of a motherboard via a bus. The second BIOS chip is connected to the Southbridge chip of a motherboard via another bus. The power supply is connected to signal pin of the Southbridge chip. The switch includes a handle. The first terminal of the switch is connected to the a detecting pin of the Southbridge chip. The second terminal of the switch is connected to the power supply. The third terminal of the switch is grounded. The first or second BIOS chip is selected to operate according to the voltage level at the detecting pin of the Southbridge chip.

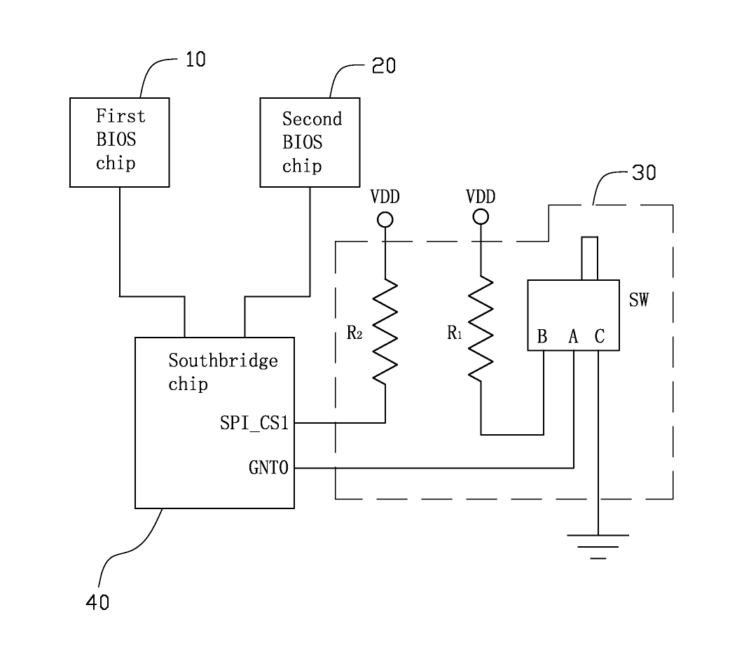

### CROSS-REFERENCE TO RELATED APPLICATIONS

Relevant subject matter is disclosed in a co-pending U.S. patent application (Attorney Docket No. US18059) filed on the same date and having a same title, which is assigned to the same assignee as this patent application.

### BACKGROUND OF THE INVENTION

1. Field of the Invention

The present invention relates to a dual bios circuit.

2. Description of Related Art

A motherboard can be destroyed through improper flashing of the BIOS (Basic Input Output System) or through manual modifications of the flash file. In such a situation, either the BIOS cannot be loaded without errors, or invalid settings are assigned to the components. For this reason, some manufacturers, such as Gigabyte, offer a dual BIOS function to many of their motherboards.

A motherboard includes two BIOS chips: a main BIOS and a backup BIOS. This type of motherboard setup helps a motherboard recover from any issue that may happen during a BIOS update, protects the BIOS from any potential virus, and helps with any other issues that may arise related to the BIOS. However, the backup BIOS is only a back-up for the main BIOS, and it has no additional functions.

The main BIOS and the backup BIOS are connected to the Southbridge chip of a motherboard via a same bus. When the bus becomes inoperable, the motherboard cannot start.

What is needed, therefore, is a dual BIOS circuit which can solve the above problems.

### SUMMARY

An exemplary dual BIOS circuit includes a first BIOS chip, a second BIOS chip, a power supply, and a switch. The first BIOS chip is connected to the Southbridge of a motherboard via a bus. The second BIOS chip is connected to the Southbridge chip of a motherboard via another bus. The power supply is connected to signal pin of the Southbridge chip. The switch includes a handle. A first terminal of the switch is connected to a detecting pin of the Southbridge chip. A second terminal of the switch is connected to the power supply. A third terminal of the switch is grounded. The first terminal is selectively connected to the second terminal or the third terminal via operating the handle. The first or second BIOS chip is selected to operate according to the voltage level at the detecting pin of the Southbridge chip.

Other advantages and novel features will become more apparent from the following detailed description when taken in conjunction with the accompanying drawing, in which:

### BRIEF DESCRIPTION OF THE DRAWINGS

The drawing is a circuit diagram of one embodiment of a dual BIOS circuit in accordance with the present invention.

### DETAILED DESCRIPTION

Referring to the drawing, a dual BIOS circuit in accordance with an embodiment of the present invention includes a first BIOS chip 10, a second BIOS chip 20, and a control circuit 30. In this embodiment, the first BIOS chip is an FWH (Firmware Hub) BIOS chip, and it loads AWARD code. The second BIOS chip is an SPI□Serial Peripheral Interface□BIOS chip, and it loads AMI code. The AWARD code and the AMI code are two different programs which are firmware used for communication between hardware and an operating system of an electronic device. The first and second BIOS chips each load a setup program. The setup program is configured for setting the voltage of GPIO pins of a motherboard.

The first and second BIOS chips each are connected to the Southbridge chip 40 of the motherboard via a bus. The Southbridge chip 40 includes an SPI_CS1 signal pin, and a GNT0 detecting pin. According to the INTEL standard, Table 1 shows voltage levels of the GNT0 detecting pin and the SPI_CS1 signal pin when the first or second BIOS chip is selected to operate.

TABLE 1

| | Voltage level | Voltage level of |
|---|---|---|
| | of GNT0 | SPI_CS1 |
| The first BIOS | 0 | 1 |
| chip | | |
| The second | 1 | 1 |
| BIOS chip | | |

The control circuit 30 includes a switch SW, a first resistor R1, and a second resistor R2. The switch SW includes a handle, a first terminal A, a second terminal B, and a third terminal C. The first terminal A is connected to the GNT0 detecting pin of the Southbridge chip 40. The second terminal B is connected to a power supply VDD via the first resistor R1. The third terminal C is grounded. The SPI_CS1 signal pin of the Southbridge chip 40 is connected to a power supply VDD via the second resistor R2. For example, the switch SW is a double-pole single-throw (DPST) switch.

When the first terminal A of the switch SW is connected to the third terminal C via the handle of the switch SW, the GNT0 detecting pin of the Southbridge chip 40 is at a TTL high level. The SPI_CS1 signal pin of the Southbridge chip 40 is at a TTL high level. Thus the first BIOS chip 10 starts.

Alternatively, when the first terminal A of the switch SW is connected to the second terminal B of the switch SW via the handle of the switch SW, the GNT0 detecting pin of the Southbridge chip 40 is at a TTL high level. The SPI_CS1 signal pin of the Southbridge chip 40 is at a TTL high level. Thus the second BIOS chip 20 starts, and the first BIOS chip 10 shuts down.

Thus, the dual BIOS circuit can make another BIOS chip start when one BIOS chip becomes inoperable via the switch SW.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternately embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A dual BIOS circuit comprising:
a first BIOS chip connected to a Southbridge chip of a motherboard via a bus;
a second BIOS chip connected to the Southbridge chip of a motherboard via another bus;
a power supply connected to a signal pin of the Southbridge chip; and
a switch comprising a handle, a first terminal of the switch connected to a detecting pin of the Southbridge chip, a second terminal of the switch connected to the power supply, a third terminal of the switch being grounded, wherein the first terminal is selectively connected to the second terminal or the third terminal via operating the handle, the first or second BIOS chip is selected to operate according to the voltage level at the detecting pin of the Southbridge chip.

2. The dual BIOS circuit as claimed in claim 1, wherein the first BIOS chip is a Firmware Hub (FWH) BIOS chip, and it loads AWARD code; the second BIOS chip is a Serial Peripheral Interface (SPI) BIOS chip, and it loads AMI code.

3. The dual BIOS circuit as claimed in claim 1, wherein the signal pin of the Southbridge chip is an SPI_CS1 signal pin.

4. The dual BIOS circuit as claimed in claim 1, wherein the detecting pin of the Southbridge chip is a GNT0 pin.

5. The dual BIOS circuit as claimed in claim 1, wherein the power supply is connected to the signal pin of the Southbridge chip via a resistor.

6. The dual BIOS circuit as claimed in claim 1, wherein the second terminal of the switch is connected to the power supply via a resistor.
